(19) United States
(12) Patent Application Publication
(10) Pub. No.: US 2010/0027185 A1
(43) Pub. Date: Feb. 4, 2010

(54) Vehicle static electricity discharge device

(76) Inventor: Jeffrey P. Jaklinski, Wyoming, MI (US)

Correspondence Address: Jeffrey P., 3435 Boone SW, Wyoming, MI, 49519, US

(21) Appl. No.: 12/221,419

(22) Filed: Aug. 4, 2008

(51) Int. Cl. H05F 3/00

(52) U.S. Cl. 361/222

(57) ABSTRACT

The vehicle static electricity discharge device is an electrostatic discharge system for a road vehicle including an electrically conducting rod in electrical contact with a. thin film resistor which in turn is in electrical contact with an electrically conducting part of the vehicle body. An actuator mountable to the vehicle can reversibly and pivotally move the conducting rod between a position that contacts the ground and a retracted position removed from ground contact. An actuator energizer operatively connected to the actuator selectively energizes the actuator for deployment of the conductor rod to contact the ground so as to provide an electrical pathway for electric charge from the electrically conducting part of the vehicle body, through the thin film resistor, and then to the ground for a predetermined interval, and wherein in the retracted position the conductor element is distanced from the ground so as to interrupt the electrical pathway.

### BACKGROUND OF THE INVENTION

1. Field of the Invention

The present invention relates generally to the dispersal of electrostatic charge from a vehicle. In particular, the present invention is concerned with providing a discharge system that enables the user, typically the vehicle driver, to safely discharge the electrostatic charge on the vehicle when desired or at predetermined situations such as, for example, when the vehicle comes to a permanent stop.

2. Description of the Related Art

Electrostatic shock from a vehicle body is a well known phenomenon. Static electricity may accumulate on parts of a vehicle's body, and also on the human occupants thereof, for a variety of reasons including by reason of friction where the exhaust gases leave the exhaust pipe or friction between the occupants' clothing and the upholstery. It is not uncommon for such occupants to receive an electric shock when alighting the vehicle, as their feet touch the ground. Typically, a spark discharge forms between the vehicle body and the occupant, when they are in close proximity and the occupant is now standing on the ground. The severity of the shock varies, and depends on local weather conditions as well as on the type of materials worn by the occupant. In some rare cases, the discharge may create a fire or explosion hazard, and lead to partial or total destruction of the vehicle and injury or death to the occupants and well as bystanders.

One commonly known attempt at solving this problem is by providing electrical communication between the vehicle body and. the ground, by means of a strap or chain that is connected to an electrically conducting part of the vehicle and that hangs therefrom to form permanent contact with the ground. Such straps or chains provide a discharge path from the vehicle to the ground for removing any electric charge buildup of the body with respect to the ground potential.

However, such straps and chains are quickly worn out or damaged by the constant contact with the ground as the vehicle travels at high speed over a range of terrains, which requires the straps or chains to be regularly monitored and replaced. Furthermore, the straps and chains are liable to cause loose materials on the roads to be ejected in a predominantly rearwards direction, thus potentially causing damage to a trailing vehicle.

Additionally, in an attempt to solve the aforementioned problems, related art vehicle static discharge devices may be deployable only when the vehicle has come to rest, may be deployable responsive to a command from the driver, and may be relatively simple to install on a vehicle. However, such related art devices are not known to have current limiting circuitry employed to safely discharge the electrostatic buildup in the vehicle.

Thus a vehicle static electricity discharge device solving the aforementioned problems is desired.

### SUMMARY OF THE INVENTION

The vehicle static electricity discharge device is an electrostatic discharge system for a road vehicle including an electrically conducting rod in electrical contact with a thin film resistor or resistor which in turn is in electrical contact with an electrically conducting part of the vehicle body. An actuator mountable to the vehicle can reversibly and pivotally move the conducting rod between a position that contacts the ground and a retracted position removed from ground contact. An actuator energizer operatively connected to the actuator selectively energizes the actuator for deployment of the conductor rod to contact the ground so as to provide an electrical pathway for electric charge from the electrically conducting part of the vehicle body, through the thin film resistor or resistor, and then to the ground, and wherein in the retracted position the conductor element is distanced from the ground so as to interrupt the electrical pathway.

These and other features of the present invention will become readily apparent upon further review of the following specification and drawings.

### BRIEF DESCRIPTION OF THE DRAWINGS

FIG. 1 is an environmental, side view of the vehicle static electricity discharge device in a retracted position, according to the present invention.

FIG. 1a is an environmental, side view of the vehicle static electricity discharge device in a retracted position, according to the present invention.

FIG. 2 is an environmental, side view of vehicle static electricity discharge device in an extended position, according to the present invention.

FIG. 2a is an environmental, side view of vehicle static electricity discharge device in an extended position, according to the present invention.

FIG. 3 is a drawing and description of the operating electrical circuit.

FIG. 4 is an exploded view of the mechanical portions of the device.

Similar reference characters denote corresponding features consistently throughout the attached drawings.

### DETAILED DESCRIPTION OF THE PREFERRED EMBODIMENT

The present invention is an electrostatic discharge system for a road vehicle including an electrically conducting rod in electrical contact with a thin film resistor or resistor which in, turn is in electrical contact with an electrically conducting part of the vehicle body. An actuator mountable to the vehicle can reversibly and pivotally move the conducting rod between a position that contacts the ground and a retracted position removed from ground contact. An actuator energizer operatively connected to the actuator selectively energizes the actuator for deployment of the conductor rod to contact the ground so as to provide an electrical pathway for electric charge from the electrically conducting part of the vehicle body, through the thin film resistor or resistor, and then to the ground, and wherein in the retracted position the conductor element is distanced from the ground so as to interrupt the electrical pathway.

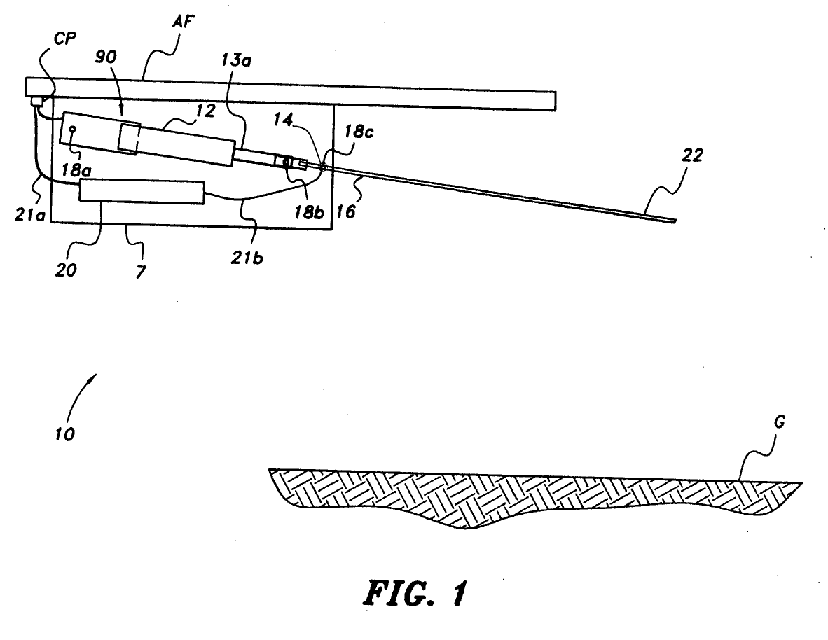

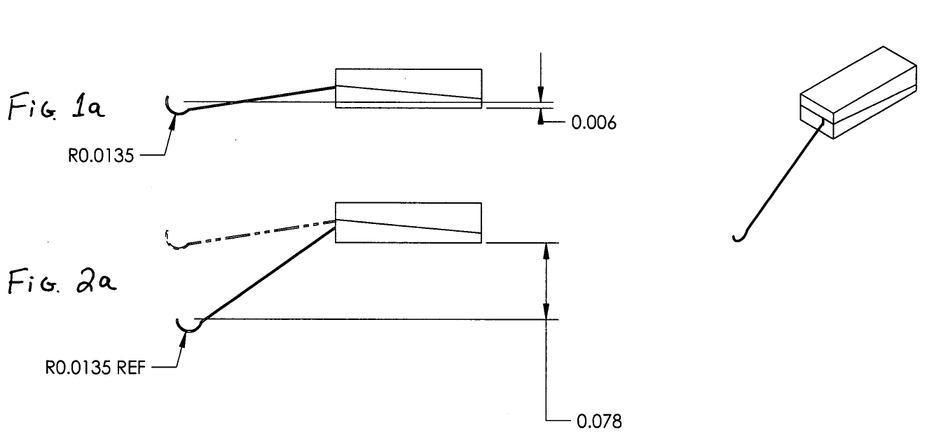

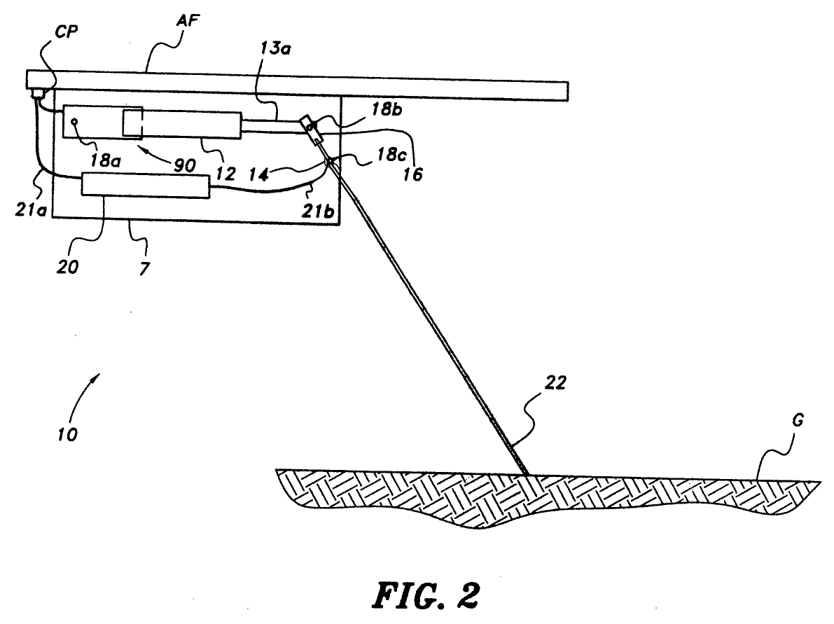

As shown in FIGS. 1-2, the system 10 comprises a thin film resistor or resistor 20 having first lead 21a and second lead 21b. Value of thin film resistor or resistor 20 is preferably selected so that electrostatic current produced by voltages likely to be encountered by the system does not exceed approximately 40 μ-amperes thereby effectively limiting discharge current to safely discharge the electrostatic buildup in the vehicle. The first lead 21a of the thin film resistor or resistor 20 is connected to a conducting portion CP of the vehicle frame AF. A rigid, electrically non-conducting tube 16 is provided, and an electrically conducting rod 22 is disposed axially in line with the rigid tube 16 and extends from one end of the rigid tube 16. The second electrically conducting lead 21b of the thin film resistor or resistor 20 is electrically connected to the conducting rod 22 either through a bore in rigid tube 16, through the pivot 18c or through some other interface means as should be well understood by one of ordinary skill in the art.

An actuator having a body portion 12 and a slidable, extensible arm portion 3a is provided and has an arm retracting spring 14 concentrically disposed around the pivot pin 18b. Fixed end of spring is attached to the housing 7. The annular attachment ring 13b is attached at a fixed point to the arm 13a. The spring 14 provides bias to the rod 22 so that when the actuator is not energized, the spring bias keeps the arm 13a and rod 22 in a retracted position.

A housing 7 is provided for the aforementioned components of system 10. Preferably the housing is affixed to underside of the vehicle auto frame AF. Body portion 12 of the actuator is pivotally attached to the housing 7 proximate rear of body portion 12 at body attachment point 18a. A free end of actuator slidable, extensible arm 13a is pivotally attached to rigid tube 16 at attachment point 18b near remaining end (end opposite extension of conducting rod 22) of the rigid tube. The rigid tube 16 is pivotally attached to the housing at attachment point 18c proximate slidable, extensible arm pivotal attachment 18b to rigid tube 16.

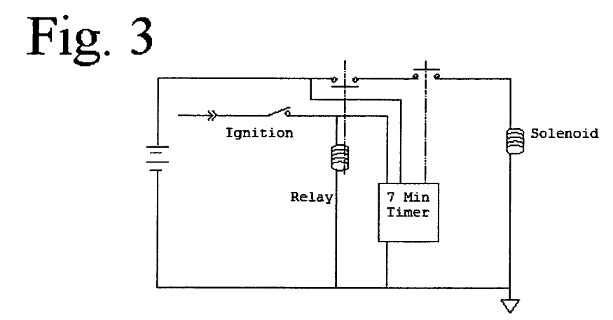

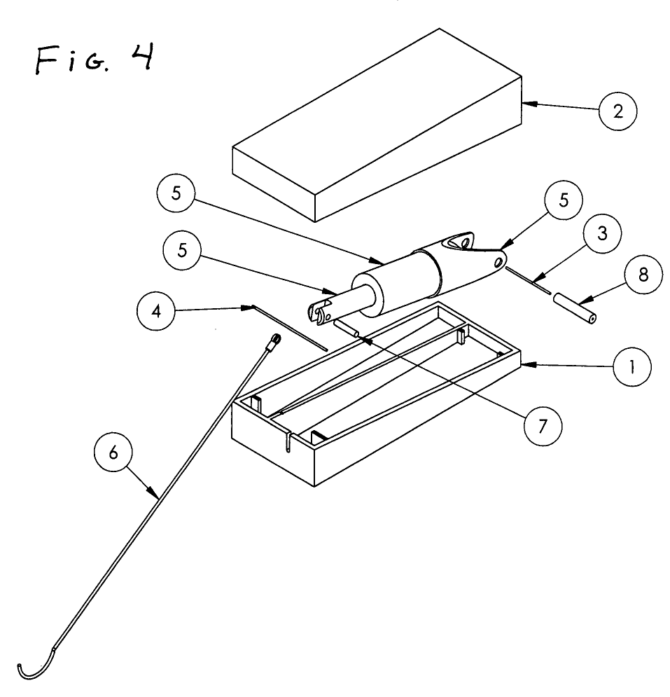

According to the present invention actuator energizing means is operably connected to the actuator 90. In the embodiment shown, actuator energizing means may be a selectively complete electrical circuit (FIG. 3) having a power source capable of energizing electric solenoid of the actuator 90.

The Relay contacts are normally closed when the Relay is not energized, and open when the Relay is energized from the ignition switch. The 7 Minute timer relay contacts are normally open, and stay open when 12 V is supplied from the intermittent source controlled by the ignition switch. The timer contacts close when the ignition switch is first opened, and stay closed for the timed interval.

The 7 Minute timer relay gets a control signal from the ignition switch, And power to operate the relay timer circuit and relay coil (internal) from the 12 V battery.

However, pneumatically controlled actuators (e.g., a vacuum diaphragm type actuator) are also contemplated by the present invention, in which case the energizing means could be a tube that selectively delivers positive or negative air pressure to the actuator for control of the actuator arm 13a.

Thus, when the actuator 90 is energized by the actuator energizing means, the slidable, extensible arm 13a extends causing the rigid tube 16 to pivot thereby swinging the electrically conducting rod 22 to contact the ground G so as to provide an electrical pathway for electric charge from the electrically conducting part of the vehicle through the thin film resistor or resistor 20 and then to the ground G for a predetermined interval, and wherein when the actuator 90 is not energized, the slidable, extensible arm 13a bias of spring 14 retracts the slidable extensible arm 13a thereby causing the rigid tube 16 to pivot in the opposite direction thus swinging the electrically conducting rod 22 away from the ground G so as to interrupt the electrical pathway to the ground.

It should be understood that the spring 14 may alternatively be configured in order to provide a reverse bias to the arm 13a, and the actuator polarity may be reverse configured so that when the actuator 90 is not energized, the spring reverse bias extends the arm 13a which pivotally swings the conducting rod 22 to the ground. In this alternative configuration of device 10, when the actuator 90 is de-energized, the arm 16 extends, and when the actuator 90 is energized, the arm 16 retracts, thus minimizing drain on a power source connected to the actuator 90 when a vehicle equipped with device 10 is turned off.

It is to be understood that the present (invention is not limited to the embodiment described above, but encompasses any and all embodiments within the scope of the following claims.

I claim:

1. A vehicle static electricity discharge device, comprising:
a resistor having first and second electrically conducting leads, the first lead being in electrical contact with a conducting part of the vehicle;
an electrically conducting rod;
a rigid, electrically non-conducting tube, the electrically conducting rod being disposed axially in line with the rigid tube and extending from one end of the rigid tube;
the second electrically conducting lead of the resistor being in electrically operable-communication with the conducting rod;
an actuator having a body portion and a slidable, extensible arm portion;
slidable, extensible arm retracting biasing means being in operable communication with the slidable, extensible arm;
a housing, the housing being affixed to the vehicle;
body portion of the actuator being pivotally attached to the housing proximate rear of body portion;
free end of the actuator slid able, extensible arm being pivotally attached to rigid tube near remaining end of rigid tube;
rigid tube being pivotally attached to the, housing proximate slidable, extensible arm pivotal attachment to rigid tube;_{—}
actuator energizing means being in operable communication with the actuator; and
wherein when the actuator is energized by the actuator energizing means, the slidable, extensible arm extends causing the rigid tube to pivot thereby swinging the electrically conducting rod to contact the ground so as to provide an electrical pathway for electric charge from the electrically conducting part of the vehicle through the resistor and then to the ground for a predetermined interval, and wherein when the actuator is not energized, the slidable, extensible arm retracting biasing means retracts the slidable extensible arm thereby causing the rigid tube to pivot in the opposite direction thus swinging the electrically conducting rod away from the ground so as to interrupt the electrical pathway to the ground.

2. A vehicle static electricity discharge device, comprising:
a resistor having first and second electrically conducting leads, the first lead being in electrical contact with a conducting part of the vehicle;
an electrically conducting rod;
a rigid, electrically non-conducting tube, the electrically conducting rod being disposed axially in line with the rigid tube and extending from one end of the rigid tube;
the second electrically conducting lead of the resistor being in electrically operable communication with the conducting rod;
an actuator having a body portion and a slidable, extensible arm portion;
slidable, extensible arm extending biasing means being in operable communication with the slidable, extensible arm;
a housing, the housing being affixed to the vehicle;
body portion of the actuator being pivotally attached to the housing proximate rear of body portion;
free end of the actuator slidable, extensible arm being pivotally attached to rigid tube near remaining end of rigid tube;
rigid, tube being pivotally attached to the housing proximate slidable, extensible arm pivotal attachment to rigid tube;
actuator energizing means being in operable communication with the actuator; and.
wherein when the actuator is disconnected from the actuator energizing means, the slidable, extensible arm extending biasing means extends. the slidable, extensible arm causing the rigid tube to pivot thereby swinging the electrically conducting rod to contact the ground so as to provide an electrical pathway for electric charge from the electrically conducting part of the vehicle through the resistor and then to the ground for a predetermined interval, and wherein when the actuator is connected to the actuator energizing means, the actuator arm counteracts the slidable, extensible arm extending biasing means to retract the slidable extensible arm thereby causing the rigid tube to pivot in the opposite direction thus swinging the electrically conducting rod away from the ground so as to interrupt the electrical pathway to the ground.
